(19) United States
(12) Patent Application Publication
(10) Pub. No.: US 2014/0062410 A1
(43) Pub. Date: Mar. 6, 2014

(54) ELECTROCHEMICAL ENERGY STORAGE CELL AND ELECTROCHEMICAL ENERGY STORAGE APPARATUS COMPRISING AT LEAST ONE SUCH ELECTROCHEMICAL ENERGY STORAGE CELL

(71) Applicants: Daimler AG, Stuttgart (DE); Li-Tec Battery GmbH, Kamenz (DE)

(72) Inventors: Tim SCHAEFER, Harztor (DE); Detlef DIEBALL, Dresden (DE)

(73) Assignees: Daimler AG, Stuttgart (DE); Li-Tec Battery GmbH, Kamenz (DE)

(21) Appl. No.: 14/011,170

(22) Filed: Aug. 27, 2013

Related U.S. Application Data
(60) Provisional application No. 61/694,810, filed on Aug. 30, 2012.
(60) Provisional application No. 61/694,821, filed on Aug. 30, 2012.

(30) Foreign Application Priority Data
Aug. 30, 2012 (DE) 10 2012 017 184.6
Aug. 30, 2012 (DE) 10 2012 017 190.0

(51) Int. Cl. H02J 7/00

(52) U.S. Cl. CPC H02J 7/00
USPC 320/127; 429/90; 429/61

(57) ABSTRACT

An electrochemical energy storage cell has an electrode assembly, containing at least one first electrode of a first polarity and at least one second electrode of a second polarity, a film-like casing, which at least partially encloses the electrode assembly; and at least one first current-conducting device, which is connected to at least one first electrode of the electrode assembly in an electrically conductive manner and projects out of the casing at least partially, and at least one second current-conducting device, which is connected to at least one second electrode of the electrode assembly in an electronically conductive manner and projects out of the casing at least partially.

The present invention relates to an electrochemical energy storage cell, particularly in the form of a pouch or coffee bag cell, and an electrochemical energy storage apparatus or battery comprising at least one such electrochemical energy storage cell.

The invention is described by way of example in connection with lithium ion batteries for the supply of motor vehicle drives. Reference is made to the fact that the invention can also be used independently of the battery design, the chemistry of the electrochemical energy storage cell and independently of the nature of the drive being supplied.

Batteries with a plurality of electrochemical energy storage cells for the supply of motor vehicle drives are known from the state of the art. Electrochemical energy storage cells are normally electrically connected to one another, particularly in order to increase the battery voltage, battery output and/or range of the motor vehicle supplied by the battery.

Customary energy storage cells comprise an electrode assembly having at least two electrodes of different polarity and a separator. The separator separates or spaces apart the electrodes of different polarity. Furthermore, customary energy storage cells comprise a cell casing, which at least partially encloses the electrode assembly. In the case of so-called pouch or coffee bag cells, this cell casing has a film-like design and generally a multi-layered structure. Further, customary energy storage cells are equipped with at least two current-conducting devices, which are connected to the electrodes of different polarity in an electrically conductive manner and project out of the casing at least partially, in order thereby to act as electrical terminals of the energy storage cells.

Particularly when used in motor vehicles, but not only there, the aspect of such batteries or energy storage cells which is particularly important is safety. Safety must also be guaranteed in this case when there are mechanical loads from outside, such as striking foreign bodies such as nails and the like. Apart from the approach of preventing the penetration of foreign bodies by means of high-strength battery housings, for example, a further problem-solving approach involves a battery or energy storage cell being at least partially discharged in a controlled manner in the event of said battery or energy storage cell being (partially) penetrated by a foreign object, in order to reduce the risk to vehicle passengers and rescue workers, for example. Protective measures of this kind become even more important as battery capacities and energy densities increase.

Therefore, it is the object of the invention to provide batteries or energy storage cells offering greater safety.

This object is achieved by an electrochemical energy storage cell comprising the features of claim 1. Particularly preferred configurations and further developments of the invention are the subject-matter of the dependent claims.

The electrochemical energy storage cell according to the invention comprises an electrode assembly, which comprises at least one first electrode of a first polarity and at least one second electrode of a second polarity; a film-like casing, which at least partially encloses the electrode assembly; and at least one first current-conducting device, which is connected to at least one first electrode of the electrode assembly in an electrically conductive manner and projects out of the casing at least partially, and at least one second current-conducting device, which is connected to at least one second electrode of the electrode assembly in an electrically conductive manner and projects out of the casing at least partially. The casing comprises at least one first functional layer, which is designed to be at least partially electrically conductive, and at least one electrical insulating layer, which separates the first functional layer from the electrode assembly in a layering direction of the casing in the normal operating state of the energy storage cell. Moreover, the at least one first functional layer of the casing is connected to a measuring apparatus, which is configured to detect an electrical operating parameter and/or a change in an electrical operating parameter of the at least one first functional layer.

If a foreign body acts on or strikes a battery according to the invention, particularly an electrochemical energy storage cell according to the invention of the battery, for example during an accident, particularly one involving a motor vehicle, the energy storage cell may be damaged. It has been observed that a conventional battery releases energy into the environment in an uncontrolled manner, particularly following damage particularly to one of its energy storage cells. The energy storage cell according to the invention offers the advantage that such a hazardous state for the energy storage cell can be detected simply, quickly and reliably by means of the special casing and the measuring apparatus. It is thereby possible to initialise suitable measures, particularly to initiate controlled discharge of the energy storage cell, when a hazardous state is detected. Safety can thereby be significantly improved for the environment of the energy storage cell. The casing having the at least one first functional layer which is connected to the measuring apparatus can therefore be also referred to as a “nail safety device”.

In the energy storage cell according to the invention, the first functional layer of the casing of the energy storage cell may change its connection to other components and/or its properties in the event of a foreign body penetrating the casing or pressure acting on the casing from outside. In particular, an electrical operating parameter of the first functional layer changes, particularly the electrical resistance between the first functional layer and another component such as, preferably, a further electrically conductive functional layer of the casing or an electrode or a current-conducting device of the energy storage cell, which can be detected by the measuring apparatus.

While the first functional layer of the casing is separated from the other electrically conductive components of the energy storage cell in the normal operating state of the energy storage cell, this insulation is either bridged by a foreign body itself during penetration of the foreign body, if this is an electrically conductive foreign body such as a metal nail, for example, or removed by deformation of the casing and direct contact between the first functional layer and the corresponding other components. The last-mentioned mechanism also comes into play when there is a particularly locally limited, particularly substantially point-based pressure application on the casing from outside.

The first functional layer is a constituent part of the film-like casing, which means that a particularly simple configuration of the electrochemical energy storage cell according to the invention with a small number of components results. In this case, the first functional layer is preferably integrated into the casing of the energy storage cell or is a constituent part of a combined multi-layered structure or is inserted as a separate structural unit. By means of this incorporation of the protective mechanism into the casing of the energy storage cell, the required increase in safety can be achieved with the energy storage cells according to the invention, irrespective of the structure of the battery comprising these energy storage cells.

An electrochemical energy storage cell within the meaning of the invention is understood to be a device which is particularly used to convert chemical energy into electrical energy at least temporarily and to make electrical energy available particularly to a consumer at least temporarily. An electrochemical energy storage apparatus must be distinguished from such an energy storage cell in this context, said energy storage apparatus accommodating one or preferably a plurality of such energy storage cells in a housing. An energy storage apparatus of this kind is also referred to as a battery within the meaning of the invention.

The electrochemical energy storage cell comprises an electrode assembly. An electrode assembly within the meaning of the invention is understood to be a device which is particularly used to provide electrical energy. The electrode assembly is preferably configured to convert stored chemical energy, in particular, into electrical energy, before the electrode assembly supplies this electrical energy to a consumer. The electrode assembly is preferably also designed to convert supplied electrical energy into chemical energy and to store it as chemical energy. This is then referred to as a rechargeable electrode assembly.

The electrode assembly comprises at least two electrodes of different polarity (first and second electrodes within the meaning of the invention). The electrodes of the electrode assembly preferably each have a particularly metallic collector film, as well as one or two active masses. The active mass is applied to at least one side of the collector film. Two active masses of different polarity are arranged on different surfaces of the collector film and spaced apart by the collector film. During the charging or discharging of the electrode assembly, electrons are exchanged between the collector film and the active mass(es). The collector film preferably comprises the materials copper and/or aluminum. Preferably, one or a plurality of conductor lugs are connected to the collector film, particularly in a substance-bonded manner, preferably formed integrally. The electrode assembly is particularly connected via the conductor lugs of the electrodes to at least two current-conducting devices of different polarity, particularly in a substance-bonded manner, said current-conducting devices serving to make the electrical connection of the electrode assembly to at least one electrode assembly of an adjacent energy storage cell and/or at least indirectly the electrical connection to battery terminals. The current-conducting devices project out of the casing at least partially for this purpose.

The electrodes of different polarity of the electrode assembly are preferably spaced apart by a separator, wherein the separator is conductive to ions, but not, or only scarcely, to electrons. The separator preferably contains at least some of the electrolyte or of the conducting salt. The electrolyte is preferably substantially formed without a liquid fraction, particularly following closure of the energy storage cell. The conducting salt preferably comprises lithium ions. Lithium ions are particularly preferably deposited or intercalated in the negative electrode during charging and removed again during discharging.

Preferably, the electrode assembly is configured as a substantially prismatic electrode stack. The electrode stack comprises a predefined sequence of stacking sheets in its stacking direction, wherein two electrode sheets of different polarity in each case are separated by a separator sheet. Preferably, electrode sheets of the same polarity are electrically connected to one another particularly via a common current-conducting device. This configuration of the electrode assembly offers the advantage that the charging capacity of the electrode assembly, indicated in ampere-hours [Ah] or in watt-hours [Wh], less commonly in coulombs [C], for example, can easily be increased by adding further electrode sheets. Particularly preferably, at least two separator sheets are connected to one another and enclose a limiting edge of an electrode sheet. An electrode assembly of this kind, comprising a single, particularly meander-shaped, separator offers the advantage that a parasitic current starting from this limiting edge to an electrode sheet of different polarity is encountered. The at least two current-conducting devices may project out of the casing either on the same side or on different sides or end faces. The current-conducting devices in this case are preferably aligned substantially perpendicular to the stacking direction of the electrode assembly.

The electrode assembly of the energy storage cell is at least partially enclosed by a film-like casing. A casing within the meaning of the invention is particularly understood to mean a device which at least partially surrounds the energy storage cell and delimits it in respect of its environment. The film-like construction of the casing enables it to provide an at least partially adaptive mechanical structure, in which components of the energy storage cell are located. The film-like casing is preferably multi-layered, i.e. made of two, three, four, five or more layers. The multiple layers of the casing are preferably permanently connected to one another and/or jointly produced in one production step as a unitary composite layer. The film-like casing preferably comprises an electrical insulating layer on its inside facing the electrode assembly. The film-like casing preferably comprises a fluid-tight layer, preferably a metal layer, which preferably acts as a water vapour barrier. Energy storage cells with film-like casings of this kind are also referred to as pouch or coffee bag cells.

The film-like casing according to the invention comprises at least one first functional layer and at least one electrical insulating layer. The casing may consist of only these functional and insulating layers within the framework of the invention, but preferably comprises still further layers or strata alongside the aforementioned layers.

According to the invention, the at least one first functional layer of the casing is connected to a measuring apparatus. The measuring apparatus is preferably connected to at least one further electrically conductive component of the energy storage cell (e.g. further functional layer, electrode, current-conducting device, etc.). These connections are preferably electrically conductive and/or heat-conductive, cabled or wireless, indirect or direct. The measuring apparatus is preferably a constituent part of the energy storage cell, i.e. it may be inserted into a battery along with this as a structural unit. The measuring apparatus may be arranged within or outside the casing in this context. In other configurations of the invention, the measuring apparatus is preferably configured as a separate component from the energy storage cell. In this configuration, a measuring apparatus may preferably also be assigned to a plurality of energy storage cells of a battery for example.

The measuring apparatus provided according to the invention is configured to detect an electrical operating parameter and/or a change in electrical operating parameter of the at least one first functional layer. All status variables which are capably of identifying the physical integrity of or damage to the casing are suitable as electrical operating parameters in this context. Included in the electrical operating parameter in this context is particularly an electrical resistance value or voltage value between the first functional layer and another electrically conductive component of the energy storage cell, which is electrically insulated from the first functional layer in the normal operating state. Further suitable electrical operating parameters are an electrical current through the first functional layer, a temperature of the first functional layer and the like, as well as combinations of the afore-mentioned operating parameters and changes therein.

In one configuration of the invention, the at least one first functional layer and/or the at least one electrical insulating layer are an integral constituent part of the casing, i.e. they form a common component along with the casing, which is disposed around the electrode assembly. In another configuration of the invention, the at least one first functional layer and the at least one electrical insulating layer are provided as a separate structural unit separate from the customary or remaining casing; they may then be connected preferably in a substance-bonded manner to the latter or fitted around the electrode assembly in a separate production step. In this configuration, the functional and insulating layers themselves may be configured in a film-like or substantially dimensionally stable manner. These functional and insulating layers in this configuration may also be disposed both within the remaining casing, both outside the remaining casing or partly within and partly outside the remaining casing.

The casing of the electrode assembly according to the invention comprises at least one, i.e. preferably one, two, three or more first functional layers and at least one, i.e. preferably one, two, three or more electrical insulating layers.

The at least one first functional layer preferably extends over the entire region of the casing, at least substantially over the total main surfaces of the casing on both sides of the electrode assembly in the stacking direction thereof, or at least substantially over the entire main surface of the casing on one side of the electrode assembly in the stacking direction thereof. In the case of a plurality, i.e. at least two first functional layers, these preferably extend substantially congruently or at least partially overlapping one another in the casing. The at least one electrical insulating layer preferably extends over the entire area of the casing or at least substantially over the entire main surfaces of the casing on both sides of the electrode assembly in the stacking direction thereof.

The at least one first functional layer is designed to be at least partially, preferably substantially over its entire area, electrically conductive. The at least one first functional layer is designed to be at least partially, preferably substantially over its entire layer thickness, electrically conductive. The at least one first functional layer is preferably formed as one piece or assembled from a plurality of sections. The at least one first functional layer is single-layered or multi-layered in design.

The at least one first functional layer of the casing is separated from the electrode assembly by at least one electrical insulating layer in the layering direction of the casing. An electrical insulating layer in this context should be understood to mean a layer with such a high electrical resistance, particularly in its layer thickness direction, which can substantially prevent an electrical current flow between the first and second electrodes of the electrode assembly over the at least one first functional layer, even with a completely charged energy storage cell and over the entire application temperature range of the energy storage cell. The necessary resistance value in this context particularly also depends on the transitional resistances between the at least one first functional layer of the casing and the first electrodes of the electrode assembly. The resistance value of the electrical insulating layer may be particularly influenced by the choice of material and the layer thickness of the insulating layer. The electrical insulating layer is single-layered or multi-layered in design.

The normal operating state of the energy storage cell, in which the at least one first functional layer of the casing is separated from the electrode assembly by the at least one electrical insulating layer in the layering direction of the casing, should be understood to mean all operating states in which charging or discharging of the energy storage cell and stable energy storage is possible without risk. The at least one electrical insulating layer separates the first functional layer(s) of the casing from the electrode assembly, at least in a risk-free normal operating state of the electrode assembly of this kind. In certain hazardous situations, particularly during the application of pressure or the action of foreign bodies on the energy storage cell or the casing thereof, the electrical insulation produced by the at least one electrical insulating layer can, on the other hand, be removed.

In a preferred configuration of the invention, the first and second current-conducting devices are connected to a discharge apparatus, which discharges the electrode assembly depending on the (change in the) operating parameter detected by the measuring apparatus. The discharge apparatus is advantageously coupled with the measuring apparatus, preferably connected to it directly or via a control apparatus inserted in between. If the measuring apparatus detects an electrical operating parameter or a change in the electrical operating parameter of the at least one first functional layer of the casing, which indicates a hazardous state of the energy storage cell, a controlled discharge of the electrode assembly of the energy storage cell is initiated via the discharge apparatus.

The discharge apparatus is a constituent part of the energy storage cell or a separate component from this. The discharge apparatus is arranged within or outside the casing of the energy storage cell. The discharge apparatus is preferably inserted between the two current-conducting devices of different polarity. The discharge apparatus advantageously contains a switching device, which separates the current path between the two current-conducting devices in the normal operating state and has the option of closing it, depending on the (change in the) operating parameter detected by the measuring apparatus. The switching device preferably comprises a semiconductor switch or a relay. The discharge apparatus or the switching device thereof can preferably be activated by the measuring apparatus and/or a control apparatus such as a battery management system, for example.

In a preferred configuration of the invention, the casing further comprises at least one second functional layer, which is designed to be at least partially electrically conductive, and at least one further electrical insulating layer, which separates the first and second functional layers of the casing from one another in the layering direction of the casing in the normal operating state of the energy storage cell.

In this configuration, the first and second functional layers of the casing are connected to one another in an electrically conductive manner or short-circuited in a hazardous state as described above, so that the electrical resistance between these functional layers is reduced or minimised, which can be detected by the measuring apparatus.

The above comments in relation to the at least one first functional layer of the casing apply correspondingly to this at least one second functional layer of the casing. The above comments in relation to the at least one insulating layer apply correspondingly to this at least one further insulating layer.

In another preferred configuration of the invention, the casing comprises at least one first functional layer in a stacking direction of the electrode assembly on the one side of the electrode assembly, said functional layer being designed to be at least partially electrically conductive and being connected in an electrically conductive manner to the at least one first electrode of the electrode assembly, and on the other side of the electrode assembly, at least one second functional layer, which is designed to be at least partially electrically conductive and is connected in an electrically conductive manner to the at least one second electrode of the electrode assembly.

The first functional layer on the one side of the electrode assembly and the second functional layer on the other side of the electrode assembly are—at least in the normal operating state of the energy storage cell—electrically insulated from one another. In the layering direction of the casing, at least one electrical insulating layer is preferably disposed between the at least one first functional layer and the electrode assembly and at least one electrical insulating layer is preferably disposed between the at least one second functional layer and the electrode assembly. The electrical insulating layers on both sides of the electrode assembly are preferably connected to one another or separated from one another. In this preferred configuration, the first and second functional layers of the casing on the different sides of the electrode assembly function independently of one another. The electrical resistances between the functional layer and the respective kind of electrode of the electrode assembly which lies on the outside in the stacking direction of the electrode assembly are preferably detected by the at least one measuring apparatus on the different sides of the electrode assembly in each case.

The above comments in connection with the at least one first functional layer of the casing apply correspondingly to these first and second functional layers of the casing.

In a variation on the last described configuration, the energy storage cell according to the invention may also be configured with a nail safety device on one side only. In this case, the casing comprises at least one first functional layer in a stacking direction of the electrode assembly on the one side of the electrode assembly, said functional layer being designed to be at least partially electrically conductive, while on the other side of the electrode assembly no functional layer which is at least partially electrically conductive is provided. In the layering direction of the casing, an electrical insulating layer is provided between the at least one first functional layer and the electrode assembly.

In yet another preferred configuration of the invention, the electrode assembly comprises outermost electrodes in a stacking direction of the electrode assembly being electrodes of the same polarity, and the casing comprises at least one first functional layer, which is designed to be at least partially electrically conductive, on both sides of the electrode assembly in a stacking direction of the electrode assembly.

The first functional layer on the one side of the electrode assembly and the first functional layer on the other side of the electrode assembly are preferably formed integrally with one another, connected to one another in an electrically conductive manner as separate components or electrically insulated from one another as separate components. In the layering direction of the casing, at least one electrical insulating layer in each case is preferably disposed between the at least one first functional layer and the electrode assembly. The electrical insulating layers on both sides of the electrode assembly are preferably connected to one another or separate from one another. The electrical resistance between the first functional layer and the outermost kind of electrode in the stacking direction is preferably detected by the at least one measuring apparatus on both sides of the electrode assembly.

In a preferred configuration of the invention the first functional layer and/or the second functional layer of the casing are substantially fluid-tight in design. With this configuration, an additional fluid-tight layer in the casing can preferably be omitted. The first or second functional layer, which is fluid-tight in design, can therefore simultaneously act as a water vapour barrier. In configurations in which a functional layer is provided on only one side of the electrode assembly, an additional fluid-tight layer is preferably provided on the other side of the electrode assembly.

In a preferred configuration of the invention, the casing comprises at least one puncture-resistant protective layer on its side of the first and/or second functional layers facing the electrode assembly. This puncture-resistant layer preferably comprises a woven or knitted fabric of reinforcing fibres, particularly aramid fibres, and/or one or a plurality of metallic inserts, which are preferably connected to one another, and/or one or a plurality of oxide-ceramic inserts, which are preferably plate-shaped in design. This configuration offers the advantage that the casing gives the foreign body a greater mechanical resistance to the penetration thereof into the inside of the energy storage cell.

In a further configuration of the invention, the electrical insulating layer of the casing facing the electrode assembly is at the same time configured as a puncture-resistant protective layer.

In a preferred configuration of the invention, the discharge apparatus connected to the current-conducting devices comprises at least one discharge resistor. This at least one discharge resistor is preferably disposed at least partially outside the casing and/or connected in a heat-conductive manner to a component outside the casing. The discharge resistor is particularly provided to convert electrical energy from the electrode assembly into heat energy during controlled discharging. In this configuration, a discharge current from the electrode assembly can be limited by the discharge resistor. In this way, the electrical heat output can also be limited. One, two, three, four or more discharge resistors are preferably provided for an energy storage cell.

Preferably, the at least one discharge resistor comprises a predetermined electrical resistance value. The total electrical resistance value is preferably at least 0.5Ω, further preferably at least 2Ω, further preferably at least 5Ω, further preferably at least 10Ω, further preferably at least 20Ω, further preferably at least 50Ω, further preferably at least 100Ω, further preferably at least 200Ω, further preferably at least 500Ω, further preferably at most 1,000Ω. The discharge resistor is particularly preferably adapted to the electrical voltage of the energy storage cell, such that the heat output in the discharge resistor during the controlled discharge of the energy storage cell is limited to maximum 500 W, further preferably to maximum 200 W, further preferably to maximum 100 W, further preferably to maximum 50 W, further preferably to maximum 20 W, further preferably to maximum 10 W, further preferably to maximum 2 W.

Through the preferred arrangement and/or heat-conductive connection of the at least one discharge resistor outside the casing, it can preferably be achieved that the heat generated by the energy storage cell during controlled discharge is released to the outside and the inside of the cell with the electrode arrangement is not heated too greatly.

In yet a further preferred configuration of the invention, the at least one first functional layer and/or the at least one second functional layer of the casing are at least partially configured as metal films.

Subject-matter of the invention is also an electrochemical energy storage apparatus, which comprises at least one electrochemical energy storage cell of the invention described above. An electrochemical energy storage apparatus of this kind can also be referred to as a battery. The energy storage apparatus further comprises a preferably dimensionally stable housing for accommodating the at least one energy storage cell and at least two battery terminals of different polarity, which are connected in an electrically conductive manner to the current-conducting devices of the at least one energy storage cell. Where there is a plurality of energy storage cells in the battery, these are preferably connected to one another in series or in parallel via their current-conducting devices between the battery terminals.

The energy storage apparatus according to the invention comprises at least one of the energy storage cells according to the invention described above. In one configuration of the invention, the energy storage apparatus exclusively comprises energy storage cells, which are configured according to the invention. In another configuration of the invention, the energy storage apparatus comprises one or a plurality of energy storage cells, which are configured according to the invention, and also one or a plurality of energy storage cells configured in some other way. In the latter case, the energy storage cells, which comprise a casing having the first and possibly second functional layers according to the invention, are preferably disposed outside in an assembly direction of the energy storage cells and therefore close to a housing wall of the battery. The advantage of this is that only the outer energy storage cells, which are exposed to greater risk of action by a foreign body, must be configured with a special casing according to the invention.

In the configuration of the discharge apparatus with at least one discharge resistor, said discharge resistor is preferably connected to the housing of the battery in a heat-conductive manner.

Within the framework of the invention, at least one of the energy storage cells may be provided with its own discharge apparatus and/or a plurality of energy storage cells may be provided with a common discharge apparatus. In this context, energy storage cells which are not configured according to the invention, i.e. in particular do not have a first functional layer in the casing and/or are not provided with a measuring apparatus, can still likewise be connected to a discharge apparatus.

Within the framework of the invention, at least one of the energy storage cells may be provided with its own measuring apparatus and/or a plurality of energy storage cells may be provided with a common measuring apparatus.

In a further preferred configuration of the invention, at least one current interrupting device is provided, which is designed to interrupt the electrically conductive connection between at least one of the battery terminals and the electrode assemblies of the at least one energy storage cell. The current interrupting device is preferably connected indirectly or directly to the aforementioned measuring apparatus.

The current interrupting device is particularly used to insulate the energy storage cell electrically with respect to its environment. With the help of the current interrupting device, the electrical connection between one of the current-conducting devices of the energy storage cell and a battery terminal particularly of the same polarity can be interrupted at least temporarily. The current interrupting device is particularly provided to be activated and in the activated state to interrupt the electrical connection between the current-conducting device and the battery terminal particularly of the same polarity. The current interrupting device preferably has a controlled switch, particularly a semiconductor switch or a relay. The current interrupting device is preferably controlled by a battery control apparatus or a battery management system. The controlled switch of the current interrupting device can preferably be closed again after a particular predetermined period of time. This preferred configuration offers the advantage that following closure of the switch the electrical voltage of the energy storage cells can be measured across the battery terminals. In another preferred configuration, the current interrupting device comprises a disconnecting device which is particularly controlled by the battery control apparatus, and an electrical conductor. The electrical conductor is inserted between the current-conducting device of the energy storage cell and the battery terminal. The disconnecting device is provided to act on the electrical conductor, such that the electrical conductivity thereof is largely, particularly substantially, completely lost. The disconnecting device is preferably configured to divide the electrical conductor, such that the current path is interrupted between the current-conducting device and the battery terminal. This preferred configuration offers the advantage of greater battery safety, particularly also following the harmful effects of a foreign body.

In a preferred configuration of the invention, the battery comprises a display device. The display device is provided particularly to display the hazardous state of the energy storage cell in relation to the functional layers of its casing and/or to transmit corresponding information, particularly to a battery control or an independent control. This configuration offers the advantage that information on the state of the battery or of the energy storage cell(s) can be made available to an individual. The display device is particularly preferably configured as a beeper, light-emitting diode, infrared interface, GPS device, GSM subassembly, first near-field device or transponder. The display device is preferably connected to the measuring apparatus(es), the discharge apparatus(es) and/or the battery control or the battery management system.

Further advantages, features and possible applications of the present invention will become apparent from the following description in conjunction with the figures. In the figures:

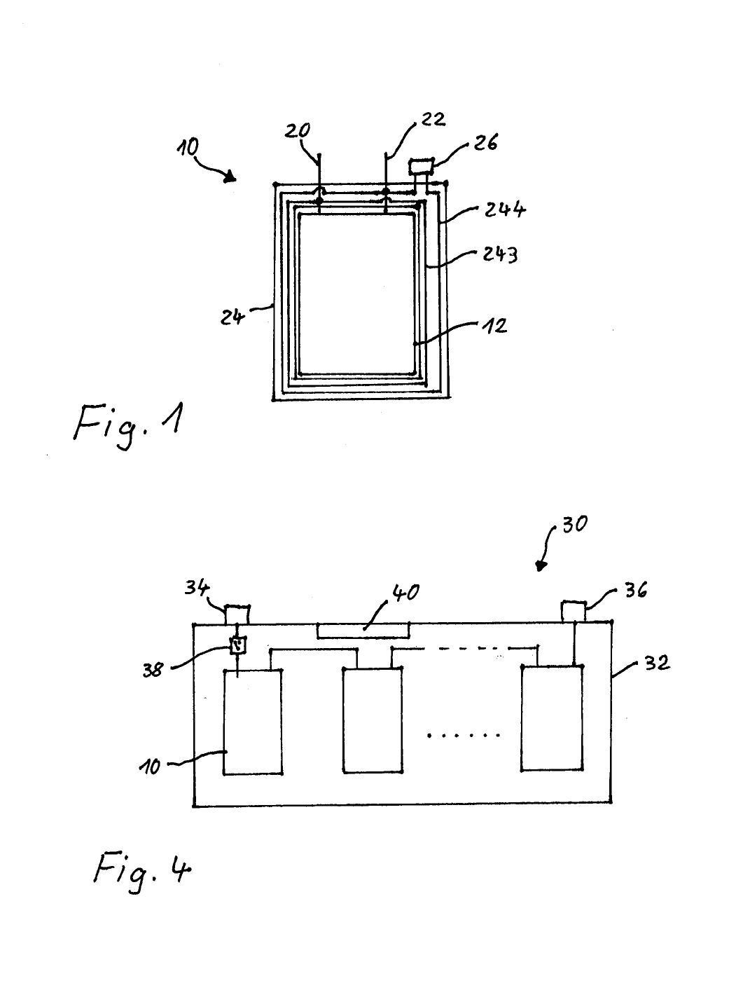

FIG. 1 shows a schematic representation of the structure of an electrochemical energy storage cell according to a preferred exemplary embodiment of the present invention;

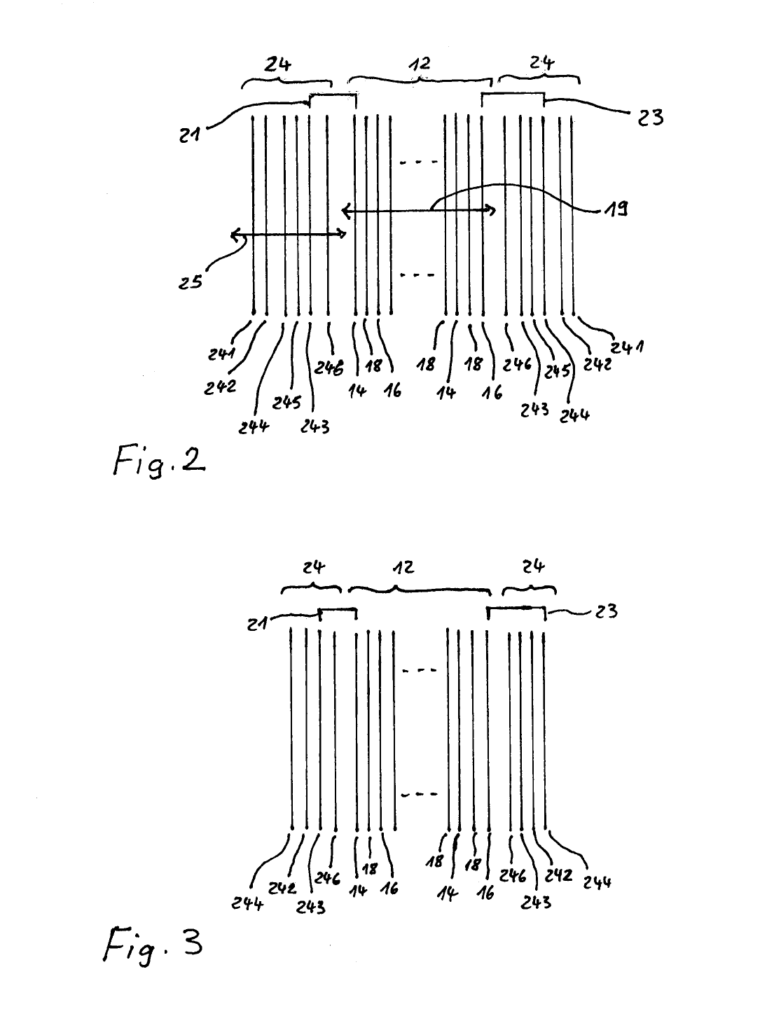

FIG. 2 shows a schematic representation of the layer structure of a casing of the energy storage cell in FIG. 1 according to a first exemplary embodiment;

FIG. 3 shows a schematic representation of the layer structure of a casing of the energy storage cell in FIG. 1 according to a second exemplary embodiment;

FIG. 4 shows a schematic representation of the structure of an electrochemical energy storage apparatus or battery with a plurality of energy storage cells according to a preferred exemplary embodiment of the present invention;

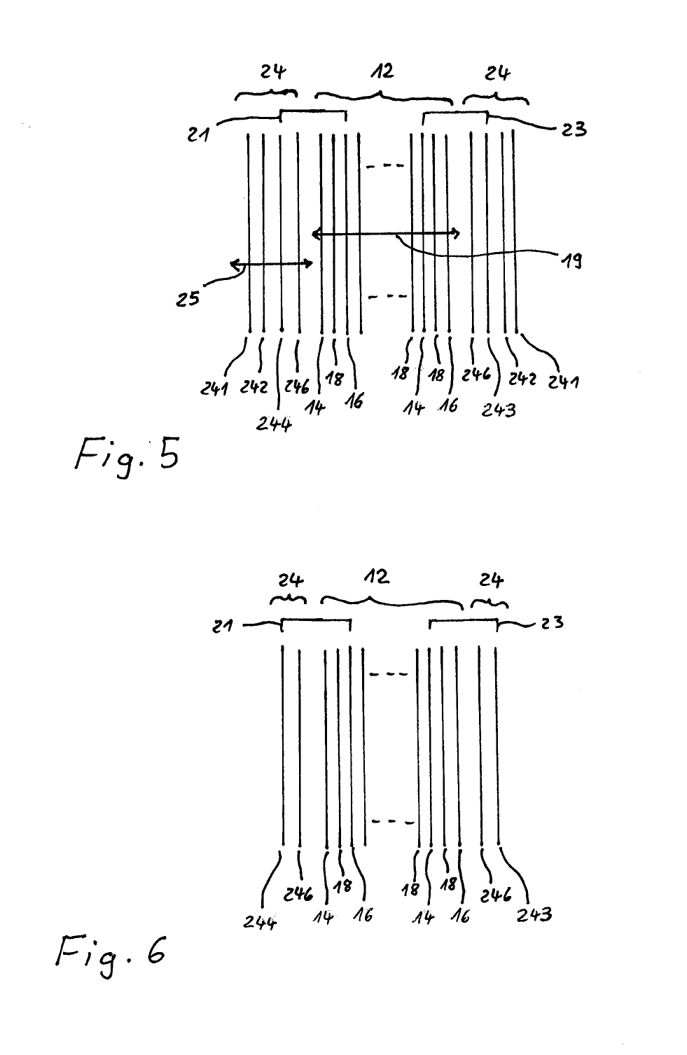

FIG. 5 shows a schematic representation of the layer structure of a casing of an energy storage cell according to a further exemplary embodiment;

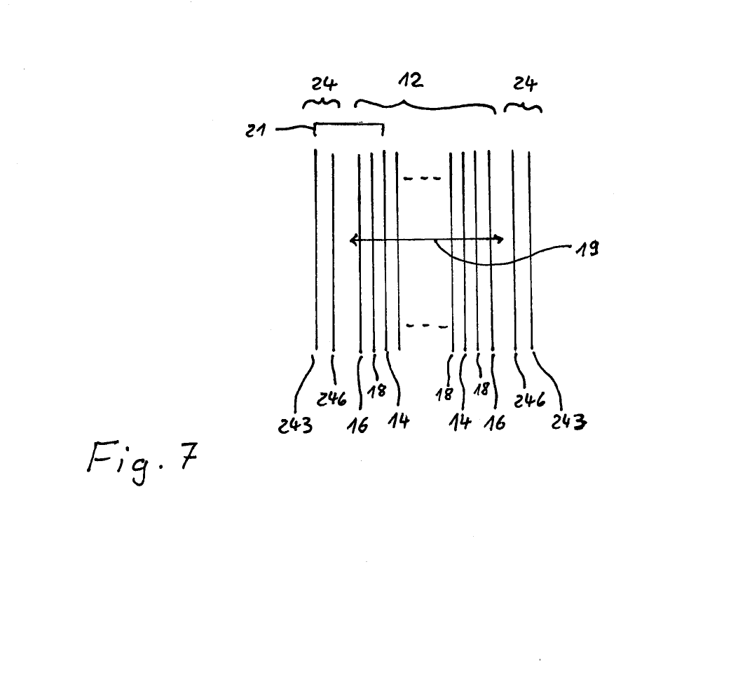

FIG. 6 shows a schematic representation of the layer structure of a casing of an energy storage cell according to yet a further exemplary embodiment; and

FIG. 7 shows a schematic representation of the layer structure of a casing of an energy storage cell according to yet a further exemplary embodiment.

FIG. 1 shows schematically the structure of a rechargeable electrochemical energy storage cell 10 in the form of a pouch cell according to the invention. The energy storage cell 10 includes an electrode assembly 12, which is substantially completely enclosed by a film-like casing 24.

As illustrated in FIGS. 2 and 3, the electrode assembly 12 comprises a substantially prismatic electrode stack made up of first electrodes 14 and second electrodes 16 of different polarity. The first and second electrodes 14, 16 are separated from one another by a separator 18.

The conductor lugs (not shown) of the first electrodes 14 are connected to a first current-conducting device (current conductor) 20 in an electrically conductive manner. The conductor lugs (not shown) of the second electrodes 16 are connected to a second current-conducting device (current conductor) 22 in an electrically conductive manner. Both current-conducting devices 20, 22 are conducted to the outside through the casing 24. The casing 24 is sealed in a fluid-tight manner in the region of these conductor through-holes.

Back to FIG. 1, a first functional layer 243 and a second functional layer 244 are indicated in the casing 24 of the electrode assembly 12. The first and the second functional layers 243, 244 are each configured as electrically conductive metal films. Moreover, the first and second functional layers 243, 244 in the layering direction 25 of the casing 24 are electrically insulated both in respect of one another and also in respect of the electrode assembly 12. In addition, the functional layers 243, 244 are also electrically insulated in respect of the current-conducting devices 20, 22 of the energy storage cell 10.

As shown in FIG. 1, a measuring apparatus 26 is provided, which is connected to the first functional layer 243 and the second functional layer 244 of the casing. The measuring apparatus 26 is configured to detect and monitor an electrical resistance value between the first and the second functional layer 243, 244 of the casing.

The first and the second functional layers 243, 244 of the casing 24 are electrically insulated from one another in the normal operating state, so that the measuring apparatus 26 detects a high resistance value. If a foreign body, for example a metal needle, strikes this energy storage cell 10, this needle may penetrate the casing 24. As soon as the electrically conductive needle makes contact with or pierces the innermost of the two functional layers of the casing 24, the two functional layers 243, 244 are connected to one another by the needle in an electrically conductive manner. The measuring apparatus 25 then detects a considerably reduced resistance value, from which a hazardous state for the energy storage cell 10 can be inferred.

The measuring apparatus 26 can also detect a change in electrical resistance value between the two functional layers 243, 244 of the casing 24 during the application of pressure from outside to the energy storage cell 10. If the pressure exceeds a given level, the casing 24 may become deformed, such that the first functional layer 243 and the second functional layer 244 are in contact with one another or the insulating layer between them is at last sharply reduced. This may occur particularly in the case of pressure forces applied to the energy storage cell 10 in an uneven, particularly substantially pointwise, manner. The same applies to the penetration of a foreign body made of a material which is not, or is barely, electrically conductive.

In addition, a discharge apparatus 28 is connected between the two current-conducting devices 20, 22 of the energy storage cell 10, by means of which the electrode assembly 12 of the energy storage cell 10 can be discharged in a controlled manner when required, i.e. particularly when a hazardous state is detected by the measuring apparatus 26. The discharge apparatus 28 is connected to the measuring apparatus 26 and/or to a control apparatus (e.g. battery control, battery management system, etc.) for this purpose.

As shown in FIG. 1, the discharge apparatus 28 includes at least one switching device (e.g. semiconductor switch, relay, etc.) 282 and at least one discharge resistor 284, which is connected in series between the first current-conducting device 20 and the second current-conducting device 22. When the energy storage cell 10 is in the normal operating state, the switching device 282 is activated open, so that the two current-conducting devices 20, 22 are separated from one another.

If the measuring apparatus 26 or a control apparatus connected thereto can infer a hazardous state for the energy storage cell 10, particularly a hazardous state of the kind described above, from the operating parameter detected by the measuring apparatus 26 or the change therein, the switching device 282 of the discharge apparatus 28 is closed and the current path between the two current-conducting devices 20, 22 is thereby closed. As a consequence, the electrode assembly 12 of the energy storage cell is discharged via this current path.

By virtue of the at least one discharge resistor 284 in the discharge apparatus 28, the electrical energy stored in the electrode assembly 12 is converted into heat energy. The at least one discharge resistor 284 is therefore preferably disposed outside the casing 24 of the energy storage cell or connected to an external component outside the casing, for example a battery housing, at least in a heat-conductive manner, so that the heat generated during the controlled discharge of the electrode assembly 12 can be emitted outwardly. The heat and the period of time involved in the discharging process can be adjusted via the resistance value of the discharge resistor 26. A positive temperature coefficient thermistor or the like may be optionally used for the discharge resistor 284 of the discharge apparatus 28.

A first exemplary embodiment of the layer structure of a casing 24 of the energy storage cell 10 according to the invention in FIG. 1 is illustrated in FIG. 2.

In this exemplary embodiment the casing 24 includes an outer, substantially fluid-tight layer 241 and an electrical insulating layer 242 on the side of the fluid-tight layer 241 facing the electrode assembly 12. This layer structure 241, 242 substantially corresponds to the structure of conventional film-like casings for pouch cells.

In addition to these two layers 241, 242, the first functional layer 243 and the second functional layer 244 are provided on the side of the layers 241, 242 facing the electrode assembly 122. An electrical insulating layer 245 is disposed between the two functional layers 243, 244.

On the inside of the first functional layer 243 facing the electrode assembly 12 an electrical insulating layer 246 is likewise provided. This insulating layer 246 should guarantee electrical insulation between the electrode assembly 12 and the casing 24—at least in the normal operating state of the energy storage cell 10.

In a special variant of this exemplary embodiment, this inner insulating layer 246 is simultaneously configured as a puncture-resistant protective layer. This is achieved, for example, by means of integrated woven fabric, knitted fabric, metal plates or the like. A foreign body should thereby be prevented from completely penetrating the casing 24 and penetrating the electrode assembly 12 of the energy storage cell 10.

The “normal” layers 241-242 of the casing 24 and the “nail safety device” layers 243-246 of the casing 24 are configured as a coherent composite layer, for example.

In another embodiment, the “normal” layers 241-242 of the casing 24 and the “nail safety device” layers 243-246 of the casing 24 are configured as separate components, which are laid around the electrode assembly 12 one after the other or are jointly laid together around the electrode assembly 12 following a preferably substance-bonded connection. In this case, the “nail safety device” layers 243-246 of the casing 24 themselves may be configured in a film-like or substantially dimensionally stable manner. Moreover, the “nail safety device” layers 243-24 of the casing 24 are provided either on both main sides of the electrode assembly 12 or on only one main side of the electrode assembly 12.

A second exemplary embodiment of the layer structure of a casing 24 of the energy storage cell 10 according to the invention in FIG. 1 is illustrated in FIG. 3.

In this exemplary embodiment, the “nail safety device” layers provided according to the invention are integrated into the “normal” casing layers. In particular, the second functional layer 244 simultaneously forms the fluid-tight layer. The electrical insulating layer 242 forms the electrical insulation between the first and the second functional layer 243, 244.

On the inside of the first functional layer 243 facing the electrode assembly 12, an electrical insulating layer 246 is also provided in this exemplary embodiment, which can optionally be configured at the same time as a puncture-resistant protective layer.

The exemplary embodiment in FIG. 3 provides a particularly compact, multifunctional layer structure of the casing 24.

Even if the layers of the casing 24 and of the electrode assembly 12 in FIGS. 2 and 3 are each represented with spaces in between, the energy storage cell 10 is preferably configured without these spaces. In particular, the casing 24 is preferably formed from a uniform composite layer 241-246 and the electrode assembly 12 is preferably configured without hollow spaces and the electrode assembly 12 preferably encloses the casing 24 without the inclusion of hollow spaces. In addition, the layers 241-246 of the casing 24 are each single-layered or multi-layered in design.

Even if in FIGS. 2 and 3 the casing 24 is represented substantially identically in the stacking direction 19 of the electrode assembly 12 on each of the two main sides, the casing 24 need not necessarily have an identical structure on both main sides of the electrode assembly 12. For example, the first and second functional layers 243, 244 may also be present only on a main side of the electrode assembly 12 in the casing 24.

In the two exemplary embodiments of FIGS. 2 and 3, the measuring apparatus 26 preferably monitors the electrical resistance value between the two functional layers 243, 244 of the casing 24 as the (change in the) operating parameter to be detected. In the normal operating state of the energy storage cell, this resistance value is relatively high on account of the insulating layer 242 or 245 between the two functional layers 243, 244. In a hazardous state of the kind described above (i.e. penetration of a foreign body, effect of pressure, etc.), this resistance value is sharply reduced, which can be easily detected and evaluated by the measuring apparatus 26, in order to activate the discharge apparatus 28 in this case.

FIG. 4 shows schematically the structure of an electrochemical energy storage apparatus or battery 30 according to the present invention.

The battery 30 has a preferably dimensionally stable housing 32. Accommodated in this housing 32 is a plurality of energy storage cells 10 enabling the desired battery capacity to be set. As indicated in FIG. 4, the electrode assemblies 12 of the energy storage cells 10 are connected in series between two battery terminals 34 and 36 via their current-conducting devices 20, 22 projecting out of the casing 24. Alternatively, the energy storage cells 10 may also be connected in parallel to one another or in a combined parallel and series connection.

The discharge resistors 284 of the discharge apparatuses 28 of the energy storage cells 10 may, for example, be connected to the housing 32 of the battery in a heat-conductive manner. In this way, the heat generated during the controlled discharge of an energy storage cell 10 can be conducted outwards via the battery housing 32.

As shown in FIG. 4, the housing 32 contains a plurality of electrochemical energy storage cells 10, which are disposed alongside one another. In one embodiment the battery 30 contains only energy storage cells 10, which comprise a casing 24 with first and second functional layers 243, 244 according to the exemplary embodiments in FIG. 2 or 3.

In another embodiment, the battery 30 also contains apart from one or a plurality of energy storage cells 10 according to the invention, one or a plurality of differently configured energy storage cells, for example conventional energy storage cells without a “nail safety device”. In this embodiment, the energy storage cells 10 according to the invention are preferably disposed in the assembly direction of the energy storage cells (right/left direction in FIG. 4) on the outside and therefore close to the housing 32 of the battery 30. The risk of action by a foreign body exists particularly on these outer energy storage cells, which is why it is sufficient for only these to be configured with a corresponding protective mechanism according to the invention.

As illustrated in FIG. 4, a current interrupting device 38 is assigned to a battery terminal 34. Moreover, a control apparatus 40 in the form of a battery management system, for example, is provided in the battery housing 32.

The control apparatus 40 is connected to, among other things, the measuring apparatuses 26 of the energy storage cells 10, in order to evaluate the measuring results thereof. Depending on the evaluation result (normal operating state, hazardous state), the control apparatus 40 controls the switching devices 282 of the discharge apparatuses 28 open or closed.

Even if not all energy storage cells 10 in the battery 30 according to the invention are configured with functional layers 243, 244 and the measuring apparatus 26, all energy storage cells 10 in the battery 30 are nevertheless preferably configured with a discharge apparatus 38 or connected in any manner. If the control apparatus 40 determines the existence of a hazardous state using the measuring results of a measuring apparatus 26 of an energy storage cell 10, it preferably activates all discharge apparatuses 28 for the controlled discharge of all energy storage cells 10 in the battery 30.

The measuring apparatuses 26 of the energy storage cells 10 and/or the control apparatus 40 are preferably also connected to the current interrupting device 38.

The current interrupting device 38 is designed to interrupt the electrically conductive connection between the battery terminal 34 and the energy storage cells 10 in the event of a hazardous state being detected, as described above, i.e. to disconnect the battery terminal 34 within the housing 32. In this way, the battery 30 can be reliably prevented from continuing to deliver electrical energy to a connected consumer in a hazardous state.

The current interrupting device 38 comprises, for example, a controlled switch, for example a semiconductor switch, or a relay. This controlled switch of the current interrupting device 38 can preferably be closed again after a predetermined period of time, so that following closure of the switch, the electrical voltage of the energy storage cells 10 can be measured across the battery terminals 34, 36. The afore-mentioned period of time is measured in this case, such that the electrode assemblies 12 of the energy storage cells 10 at risk from a foreign body or from pressure can discharge at least for the most part via the discharge apparatuses 28.

Although not shown, the battery 30 may also comprise a display device. This display device is provided to indicate the hazardous state of the energy storage cells 10 detected by the measuring apparatus 26. With the help of the display device, information on the state of the battery 30 or of the energy storage cell(s) 10 can be made available to an individual.

FIG. 5 shows schematically the layer structure of a casing of the energy storage cell 10 according to a third exemplary embodiment.

This exemplary embodiment is distinguished from the exemplary embodiment shown in FIG. 2 principally in that in the stacking direction 19 of the electrode assembly 12 (right/left direction in FIG. 5) only one functional layer is provided in the casing 24 on both sides of the electrode assembly 12.

On the one side of the electrode assembly 12 (on the left in FIG. 5) the casing 24 only comprises (at least) one electrically conductive second functional layer 244 alongside the fluid-tight layer 241 and the electrical insulating layer 242. Between this second functional layer 244 and the electrode assembly 12 an electrical insulating layer 246 is provided in the layering direction 25 of the casing 24 (right/left direction in FIG. 5). On the other side of the electrode assembly 12 (on the right in FIG. 5) the casing 24 only comprises (at least) one electrically conductive first functional layer 243 alongside the fluid-tight layer 241 and the electrical insulating layer 242. Between this first functional layer 243 and the electrode assembly 12 an electrical insulating layer 246 is provided in the layering direction 25 of the casing 24 (right/left direction in FIG. 5). The electrical insulating layers 246 on both sides of the electrode assembly 12 are preferably configured as a continuous, uniform insulating layer.

If a foreign body, for example a metal needle, strikes this energy storage cell 10, said needle may pierce the casing 24. As soon as the electrically conductive needle comes into contact with the electrode assembly 12, i.e. the outermost electrode thereof, the functional layer 243, 244 of the casing 24 in each case is connected by the needle to this outer electrode 16, 14 in an electrically conductive manner.

In this exemplary embodiment, the first functional layer 243 is connected to a first measuring apparatus 26 on the one side of the electrode assembly 12 and the second functional layer 244 is connected to a second measuring apparatus 26 on the other side of the electrode assembly. Both measuring apparatuses 26 are connected to the one discharge apparatus 28 and to the control apparatus 40 of the battery 30.

Otherwise, the structure of the energy storage cell in FIG. 5 corresponds to the first exemplary embodiment in FIG. 2. The energy storage cell in FIG. 5 can also be used correspondingly in a battery according to FIG. 4.

FIG. 6 shows schematically the layer structure of a casing of the energy storage cell 10 according to a fourth exemplary embodiment.

This exemplary embodiment is based on a combination of the third exemplary embodiment in FIG. 5 and the second exemplary embodiment in FIG. 3. In particular, the casing 24 in the stacking direction 25 of the electrode assembly 12 contains only one functional layer 243 or 244 on either side of the electrode assembly 12 and this (at least) one functional layer 243, 244 is compactly integrated into the casing 24.

In a variant according to the invention in FIGS. 5 and 6, the casings 24 of the energy storage cells 10 may also each be provided with an electrically conductive functional layer 243, 244 on only one main side of the electrode assembly 12 (i.e. only on the right or left in the figures).

Otherwise, the structure of the energy storage cell in FIG. 6 corresponds to the second exemplary embodiment in FIG. 3. The energy storage cell in FIG. 6 can also be used in a corresponding manner in a battery according to FIG. 4.

In the two exemplary embodiments in FIGS. 5 and 6, the measuring apparatus 26 preferably monitors the electrical resistance value between the one functional layer 243, 244 of the casing 24 and the outermost electrode 16, 14 in each case of the electrode assembly 12 as the (change in the) operating parameter to be detected. In the normal operating state of the energy storage cell, these resistance values are relatively high due to the insulating layer 246. In a hazardous state of the kind described above (i.e. penetration of a foreign body, effects of pressure, etc.) this resistance value is sharply reduced on the corresponding side of the electrode assembly 12, something that can be easily detected and evaluated by the measuring apparatus 26 in question, in order to activate the discharge apparatus 28 in this case.

FIG. 7 shows schematically the structure of an energy storage cell 10 according to a fifth exemplary embodiment.

This exemplary embodiment differs from the exemplary embodiment shown in FIG. 6 primarily in that in the stacking direction 19 of the electrode assembly 12 (right/left direction in FIG. 7), a second electrode (i.e. electrode of second polarity) 16 in each case is disposed as the outermost electrode of the subassembly 12 and the casing 24 on both sides of the electrode assembly 12 includes at least one first functional layer 243. This first functional layer 243 and also the electrical insulating layer 246 may extend continuously over the entire casing 24 in this case. The structure of the casing 24 may be further simplified in this way.

In this exemplary embodiment a measuring apparatus 26 is sufficient which monitors the electrical resistance value between the (surrounding) first functional layer 243 of the casing 24 and the second electrode 16 or the second current-conducting device 22.

Otherwise, the structure of the energy storage cell in FIG. 7 corresponds to the exemplary embodiments in FIGS. 3 and 6. The energy storage cell in FIG. 7 can also be used in a corresponding manner in a battery according to FIG. 4.

Moreover, the exemplary embodiments described above may be combined with one another in any manner, in order to obtain further embodiments according to the present invention.

### LIST OF REFERENCE NUMBERS

10 Energy storage cell
12 Electrode assembly
14 First electrodes
16 Second electrodes
18 Separator
19 Stacking direction of 12
20 First current-conducting device
22 Second current-conducting device
24 Casing
241 Fluid-tight layer
242 Electrical insulating layer
243 First functional layer
244 Second functional layer
245 Further electrical insulating layer
246 Electrical insulating layer and/or puncture-resistant protective layer
25 Layering direction of 24
26 Measuring apparatus
28 Discharge apparatus
282 Switching device
284 Discharge resistor
30 Energy storage apparatus or battery
32 Housing
34 First battery terminal
36 Second battery terminal
38 Current interrupting device
40 Control apparatus

1. An electrochemical energy storage cell comprising:
an electrode assembly, comprising at least one first electrode of a first polarity and at least one second electrode of a second polarity;
a film-like casing, which at least partially encloses the electrode assembly, and
at least one first current-conducting device, which is connected to at least one first electrode of the electrode assembly in an electrically conductive manner and projects out of the casing at least partially, and at least one second current-conducting device, which is connected to at least one second electrode of the electrode assembly in an electrically conductive manner and projects out of the casing at least partially,
wherein the casing comprises at least one first functional layer, which is designed to be at least partially electrically conductive, and at least one electrical insulating layer, which separates the first functional layer from the electrode assembly in a layering direction of the casing in the normal operating state of the energy storage cell; and
the at least one first functional layer of the casing is connected to a measuring apparatus, which is configured to detect an electrical operating parameter or a change in an electrical operating parameter of the at least one first functional layer.

2. The energy storage cell according to claim 1, wherein the first and second current-conducting devices are connected to a discharge apparatus, which discharges the electrode assembly depending on the change in the operating parameter detected by the measuring apparatus.

3. The energy storage cell according to claim 1, wherein the casing further comprises at least one second functional layer, which is at least partially electrically conductive, and at least one further electrical insulating layer, which separates the first and second functional layers of the casing from one another in the layering direction of the casing in the normal operating state of the energy storage cell.

4. The energy storage cell according to claim 1, wherein the casing comprises at least one first functional layer in a stacking direction of the electrode assembly on one side of the electrode assembly, said functional layer being at least partially electrically conductive, and on another side of the electrode assembly, at least one second functional layer, which is at least partially electrically conductive and is electrically insulated from the first functional layer.

5. The energy storage cell according to claim 1, wherein
the electrode assembly comprises outermost electrodes in a stacking direction of the electrode assembly being electrodes of the same polarity; and
the casing comprises at least one first functional layer, which is at least partially electrically conductive, on both sides of the electrode assembly in a stacking direction of the electrode assembly.

6. The energy storage cell according to claim 3, wherein at least one of the first functional layer and the second functional layer of the casing is substantially fluid-tight.

7. The energy storage cell according to claim 3, wherein the casing comprises at least one puncture-resistant protective layer on a side of the first or second functional layers facing the electrode assembly in the layering direction of the casing.

8. The energy storage cell according claim 2, wherein the discharge apparatus connected to the current-conducting devices comprises at least one discharge resistor disposed at least partially outside the casing (24) or connected to a component outside the casing in a heat-conductive manner.

9. The energy storage cell according to claim 3, wherein the at least one first functional layer or the at least one second functional layer of the casing are at least partially configured as metal films.

10. An electrochemical energy storage apparatus comprising
at least one electrochemical energy storage cell (10), wherein at least one of the at least one energy storage cell is configured according to claim 1;
a housing to accommodate the at least one energy storage cell; and
at least two battery terminals of different polarity, which are connected in an electrically conductive manner to the current-conducting devices of the at least one energy storage cell.

11. The energy storage apparatus according to claim 10, wherein at least one of the at least one energy storage cell is provided with a discharge apparatus.

12. The energy storage apparatus according to claim 10, wherein at least one of the at least one energy storage cell provided with a measuring apparatus.

13. The energy storage apparatus according claim 10, wherein at least one current interrupting device is provided to selectively interrupt the electrically conductive connection between at least one of the battery terminals and the current-conducting devices of the at least one energy storage cell.

14. The energy storage apparatus according to claim 10, further comprising:
a display device configured to display a hazardous state of at least one of the at least one energy storage cell in relation to the functional layers of the casing of the at least one energy storage cell.

15. The energy storage apparatus according to claim 10, wherein a plurality of the at least one energy storage cell is provided with a common discharge apparatus.

16. The energy storage apparatus according to claim 10, wherein a plurality of the at least one energy storage cell is provided with a common measuring apparatus.
